(19) United States
(12) Patent Application Publication
(10) Pub. No.: US 2019/0079196 A1
(43) Pub. Date: Mar. 14, 2019

(54) PSEUDO SATELLITE NAVIGATION SIGNAL REPEATING DEVICE AND OPERATING METHOD OF PSEUDO SATELLITE NAVIGATION SIGNAL REPEATING DEVICE

(71) Applicant: TELACE, INC., Seoul (KR)

(72) Inventors: Jin-Hee Han, Gyeonggi-do (KR); Byeong-Gyu An, Incheon (KR); Hak-Du Kim, Seoul (KR); Kang-Suk Kim, Seoul (KR)

(21) Appl. No.: 15/809,391

(22) Filed: Nov. 10, 2017

(30) Foreign Application Priority Data
Sep. 13, 2017 (KR) 10-2017-0117023

(51) Int. Cl. G01S 19/11

(52) U.S. Cl. CPC G01S 19/11

(57) ABSTRACT

A pseudo satellite navigation signal repeating device includes a communication interface configured to collect orbit information of navigation satellites from a global navigation satellite information server through a network, a controller configured to calculate pseudo ranges from associated navigation satellites based on associated orbit information of the associated navigation satellites among orbit information of all the navigation satellites, a signal generator configured to generate global navigation satellite baseband digital signals of the associated navigation satellites based on the pseudo ranges, a signal converter configured to convert the navigation signals into analog baseband or intermediate frequency band signals, and a modulator configured to modulate the analog baseband or intermediate frequency band signals using a wireless carrier signal.

### CROSS-REFERENCE TO RELATED APPLICATION

This U.S. non-provisional patent application claims priority under 35 U.S.C. § 119 to Korean Patent Application No. 10-2017-0117023, filed on Sep. 13, 2017, in the Korean Intellectual Property Office, the entire contents of which are hereby incorporated by reference.

### TECHNICAL FIELD

The present disclosure relates to a pseudo satellite navigation signal repeating device and an operating method of the same.

### BACKGROUND

Navigation technologies are keeping pace with the advance in scientific technologies. A representative navigation technology widely used in recent years is a global navigation satellite system (hereinafter referred to as “GNSS”). GNSS is a system that determines a location of a receiver based on signals received from navigation satellites installed on the earth's orbit.

GNSS includes a global positioning system (GPS) studied in USA, Galileo studied in Europe, GLONASS studied in Russia, Beidou studied in China or the like.

GNSS provides various advantages in association with a navigation device combined with means of transportation or a mobile device such as smartphone or tablet PC having a navigation function. Disadvantageously, GNSS does not operate at a location such as basement or inside of a building that a satellite navigation signal cannot reach.

Various means have been studied to overcome the above disadvantage. However, means studied up to now cause an overhead that should partially give up accuracy or change a part of GNSS. Accordingly, there is a requirement for ongoing studies on a satellite navigation device or method that has higher accuracy than the means studied up now and is compatible with an existing GNSS.

### SUMMARY

An objective of the present disclosure is to provide a pseudo satellite navigation signal repeating device with more improved accuracy than existing studied means and an operating method of the pseudo satellite navigation signal repeating device.

A pseudo satellite navigation signal repeating device according to an example embodiment of the present disclosure includes: a communication interface configured to collect orbit information of navigation satellites from a global navigation satellite information server through a network; a controller configured to calculate pseudo ranges from associated navigation satellites based on associated orbit information of the associated navigation satellites among orbit information of all the navigation satellites; a signal generator configured to generate navigation signals of the associated navigation satellites based on the pseudo ranges; a signal converter configured to convert the navigation signals into analog signals of baseband or intermediate frequency band; and a modulator configured to modulate the analog signals using a wireless carrier signal.

In an example embodiment, the controller may select navigation satellites calculated to transmit navigation signals to a current location at a current time as the associated navigation satellites, based on the orbit information.

In an example embodiment, the signal generator may adjust timings of starts of frames of the navigation signals, based on the pseudo ranges.

In an example embodiment, the controller may calculate Doppler frequencies of the navigation signals, based on the associated orbit information. The modulator may modulate the analog signals using the Doppler frequencies, respectively.

In an example embodiment, the controller may calculate output intensity, based on information of a transmission range.

In an example embodiment, the pseudo satellite navigation signal repeating device may further include: an output amplifier/attenuator configured to regulate intensities of the modulated signals based on the output intensity and output the regulated signals.

In an example embodiment, the controller may include a location information storage unit configured to store information on a location at which the pseudo satellite navigation signal repeating device is installed. The controller may calculate the pseudo ranges, based on the associated orbit information and the location information.

In an example embodiment, the location information storage unit may receive and store the location information through the communication interface.

In an example embodiment, the controller may include a satellite information obtaining unit configured to obtain orbit information of the navigation satellites by periodically connecting to the global navigation satellite information server through the communication interface.

In an example embodiment, the controller includes a clock. The controller may output time information obtained from the clock together with the pseudo ranges to the signal generator. The signal generator may generate the navigation signals, based on the pseudo ranges and the time information.

In an example embodiment, the controller may include a time correction unit configured to synchronize a time of the clock with a time of a time information server by periodically connecting to the time information server through the communication interface.

In an example embodiment, the controller may periodically reselect the associated navigation satellites and recalculate pseudo ranges of the reselected navigation satellites.

In an example embodiment, the controller may compensate the pseudo ranges by considering earth's rotation, an ionospheric layer, and a convection layer.

An operating method of a pseudo satellite navigation signal repeating device according to an example embodiment of the present disclosure includes: obtaining associated orbit information of orbit satellites associated with a current location; calculating locations of the associated navigation satellites, based on the associated orbit information; calculating pseudo ranges of the associated navigation satellites, based on the locations; generating navigation signals of the associated navigation satellites, based on the pseudo ranges; and modulating the navigation signals using a wireless carrier frequency.

In an example embodiment, the operating method may further include: obtaining time information. Generating the navigation signal may be performed based on the obtained time information.

In an example embodiment, the operating method may further include: calculating relative speeds of the associated navigation satellites, based on the associated orbit information; and calculating Doppler frequencies of the associated navigation satellites, based on the relative speeds. Modulating the navigation signals may include modulating the navigation signals using wireless carrier frequencies based on the Doppler frequencies, respectively.

In an example embodiment, the operating method may further include: correcting the pseudo ranges by considering earth's rotation, an ionospheric layer, and a convection layer. Generating the navigation signals may be performed based on the corrected pseudo ranges.

In an example embodiment, the operating method may further include: calculating output intensity of the navigation signals, based on the information of a transmission range; adjusting intensities of the modulated navigation signals, based on the output intensity; and transmitting the adjusted navigation signals.

In an example embodiment, the operating method may further include: periodically obtaining orbit information of navigation satellites from a global navigation satellite information server through a network. The associated orbit information of the associated navigation satellites may be selected from the orbit information.

In an example embodiment, obtaining the associated orbit information, calculating the locations, calculating the pseudo ranges, and generating the navigation signals may be periodically performed. Modulating the navigation signals may include modulating currently updated navigation signals or previously updated navigation signals.

### BRIEF DESCRIPTION OF THE DRAWINGS

The present disclosure will become more apparent in view of the attached, example drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the present disclosure.

FIG. 1 is a block diagram of a pseudo satellite navigation signal repeating device according to an example embodiment of the present disclosure.

FIG. 2 is a block diagram of a controller according to an example embodiment of the present disclosure.

FIG. 3 is a flowchart illustrating an operating method of a pseudo satellite navigation signal repeating device according to an example embodiment of the present disclosure.

FIG. 4 is a flowchart illustrating an example of a method for storing location information by a location information storage unit.

FIG. 5 is a conceptual diagram of a configuration to directly input location information from an external device through wire communication, as an example of a system in which location information is stored in a location information storage unit.

FIG. 6 is a flowchart illustrating an example of updating satellite information by a satellite information obtaining unit according to an example embodiment of the present disclosure.

FIG. 7 is a flowchart illustrating an example of correcting the time of a clock by a time correction unit according to an example embodiment of the present disclosure.

FIG. 8 illustrates an example of a system in which a pseudo satellite navigation signal repeating device updates information of satellite orbits and time information.

FIG. 9 is a flowchart illustrating an example of updating navigation signals by a pseudo satellite navigation signal repeating device according to an example embodiment of the present disclosure.

FIG. 10 illustrates an example of a system in which a pseudo satellite navigation signal repeating device transmits navigation signals to a user device in an indoor space.

FIG. 11 illustrates an example of navigation signals that a pseudo satellite navigation signal repeating device receives.

FIG. 12 illustrates another example of a system in which a pseudo satellite navigation signal repeating device according to an example embodiment of the present disclosure receives navigation signals.

### DETAILED DESCRIPTION

Example embodiments will now be described more fully with reference to the accompanying drawings, in which some example embodiments are shown. Example embodiments may, however, be embodied in many different forms and should not be construed as being limited to the embodiments set forth herein; rather, these example embodiments are provided so that this disclosure will be thorough and complete, and will fully convey the scope of example embodiments of the present disclosure to those of ordinary skill in the art. In the drawings, the thicknesses of layers and regions are exaggerated for clarity. Like reference characters and/or numerals in the drawings denote like elements, and thus their description may be omitted.

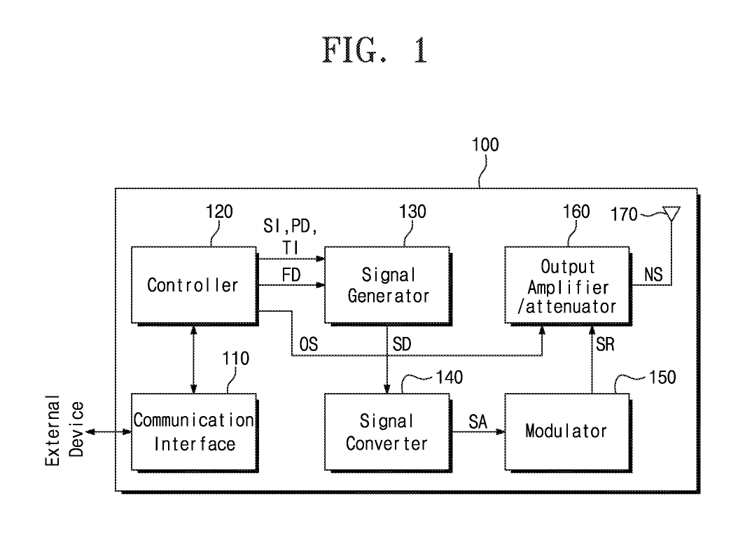

FIG. 1 is a block diagram of a pseudo satellite navigation signal repeating device 100 according to an example embodiment of the present disclosure. Referring to FIG. 1, the pseudo satellite navigation signal repeating device 100 includes a communication interface 110, a controller 120, a signal generator 130, a signal converter 140, a modulator 150, an output amplifier/attenuator 160, and an antenna 170.

The communication interface 110 may communicate with an external device through a wire or wireless channel. For example, the communication interface 110 may be directly connected to the external device to communicate with the external device and may be remotely connected to the external device through a network to communicate with the external device. The communication interface 110 may include wire interfaces such as USB (Universal Serial Bus), PCIe (Peripheral Component Interconnect express), and SATA (Serial Advanced Technology Attachment) or wireless interfaces such as IEEE 802.11 (WiFi), Bluetooth, NFC (Near Field communication), and LPWA (Low Power Wide Area) (e.g., LoRa, LTE-M, NB-IoT, etc.).

The controller 120 may collect a variety of information from the external device through the communication interface 110. For example, the controller 120 may collect information on orbits of navigation satellites, information on current time or information on a current location through the communication interface 110. The controller 120 may calculate and output pseudo ranges PD, time information TI, Doppler frequencies FD, and an output intensity OS based on the collected information.

The pseudo ranges PD indicates a calculated value (or an estimated value) with respect to distances between a location registered in the pseudo satellite navigation signal repeating device 100 (hereinafter referred to as “current location”) and locations of an associated navigation satellite. Associated navigation satellites are disposed on the earth's orbit, participate in a global navigation satellite system, and corresponds to navigation satellites from which that a device is capable of receiving navigation signals at a current location.

In other words, the pseudo ranges PD indicate distances between navigation satellites transmitting navigation signals reaching the pseudo satellite navigation signal repeating device 100 and the current location of the pseudo satellite navigation signal repeating device 100 in an environment in which the pseudo satellite navigation signal repeating device 100 is capable of receiving navigation signals. The term “pseudo range” is used herein in that it is not a distance between actual navigation satellites and the pseudo satellite navigation signal repeating device 100 but a calculated (or estimated) distance. However, the inventive concept of the present disclosure is not limited to the term “pseudo range”.

The controller 120 may calculate pseudo ranges PD based on information of orbits of associated navigation satellites and a current location. The controller 120 may obtain time information TI from an internal clock. The controller 120 may transmit information SI of the associated navigation satellites, the pseudo ranges PD, and the time information TI to the signal generator 130. The information SI of the associated navigation satellites may include information on what pseudo random number (PRN) is associated with the associated navigation satellites and information on the orbits of the associated navigation satellites.

The controller 120 may calculate relative speeds to a current location of the pseudo satellite navigation signal repeating device 100 of the associated navigation satellites, based on information of the orbits of the associated navigation satellites. The controller 120 may calculate Doppler frequencies of navigation signals of the associated navigation satellites, based on the relative speeds. The controller 120 may transmit the calculated Doppler frequencies to the signal generator 130.

The controller 120 may calculate output intensity OS of navigation signals, based on information of a predetermined transmission range. For example, the information of the transmission range may be directly input by a user or may be input from another device through wire or wireless communication. The controller 120 may set the calculated output intensity OS to the output amplifier/attenuator 160.

The signal generator 130 may generate digital signals SD, based on the information SI of the associated navigation satellites, the pseudo ranges PD, and the time information TI. The digital signals SD may be finally processed as navigation signals NS that the pseudo satellite navigation signal repeating device 100 outputs. The digital signals SD may be global navigation satellite baseband digital signals. Therefore, the procedure of generating the digital signals SD by the signal generator 130 will be described in relation to terms of the “navigation signals NS”.

For example, the signal generator 130 may select a pseudo random number (PRN) to be included in each frame of the navigation signals NS according to the information SI of the associated navigation satellites. The signal generator 130 may include selected pseudo random numbers and orbit information in the digital signals SD, respectively.

The signal generator 130 receives Doppler frequencies FD from the controller 120. The signal generator 130 may reflect the Doppler frequencies FD in the associated navigation signals NS. The signal generator 130 may select time information to be included in each frame of the navigation signals NS according to the time information TI.

The signal generator 130 may adjust timings of starts of frames (SOF) of the digital signals SD, based on the pseudo ranges PD. For example, as a pseudo range increases, the signal generator 130 may increases the delay of SOF of a corresponding digital signal. As a pseudo range decreases, the signal generator 130 may decrease the delay of SOF of a corresponding digital signal. The signal generator 130 may generate digital signals SD by combining corresponding navigation digital signals.

The signal converter 140 may receive the digital signals SD from the signal generator 130. The signal converter 140 may convert the digital signals SD into analog signals SA. The analog signals SA may be analog baseband or intermediate frequency band signals. For example, the signal converter 140 may generate the analog signals by modulating the digital signals SD using a base band signal or an intermediate frequency signal. The analog signals SA are transmitted to the modulator 150.

The modulator 150 receives the analog signals SA from the signal converter 140. The modulator 150 may modulate the analog signals SA. For example, the modulator 150 may sequentially modulate the analog signals SA using an intermediate frequency or a carrier frequency. Alternatively, the modulator 150 may modulate the analog signals SA at once directly using a carrier frequency.

Signals SR modulated by the modulator 150 may have frequencies of a wireless frequency band. The modulated signals SR are transmitted to the output amplifier/attenuator 160. The output amplifier/attenuator 160 may receive the modulated signals SR from the modulator 150 and receive the output intensity OS from the controller 120. The output amplifier/attenuator 160 may regulate intensities of the modulated signals SR based on the output intensity OS and output a regulated result as the navigation signals NS. The navigation signals NS are radiated through the antenna 170.

As described above, the pseudo satellite navigation signal repeating device 100 may obtain orbits of navigation satellites from an external device, e.g., a global navigation satellite information server through the communication interface 110. The pseudo satellite navigation signal repeating device 100 may detect navigation satellites calculated (or estimated) as navigation signals reach at the current time and may simulate and output navigation signals that the detected navigation satellites (or associated navigation satellites) transmit.

That is, the pseudo satellite navigation signal repeating device 100 may generate and radiate navigation signals calculated (or estimated) to be currently reached, even in an environment that the navigation signals do not reach. Thus, the pseudo satellite navigation signal repeating device 100 may transmit navigation signals in an environment, such as basement or indoor space, that the navigation signals do not reach.

The pseudo satellite navigation signal repeating device 100 may calculate and transmit navigation signals using a current location and locations of navigation satellites. As compared to an existing satellite navigation signal repeater that transmits only corresponding signal at location of an outdoor antenna receiving satellite navigation signals irrespective of location to be retransmitted, and reradiates poorly received signals as it is at an outdoor antenna (e.g., a signal which is block to be unable to be received, an attenuated signal, a multi-path signal, etc.), accuracy and reliability of location information calculated by navigation signals of the pseudo satellite navigation signal repeating device 100 are improved.

Moreover, the pseudo satellite navigation signal repeating device 100 transmits navigation signals that has the same format as existing navigation signals and includes the same type of information as the existing navigation signals. Accordingly, no correction is required for an existing global navigation satellite system and high compatibility is achieved when the pseudo satellite navigation signal repeating device 100 is applied.

In an example embodiment, some of components of the pseudo satellite navigation signal repeating device 100 shown in FIG. 1 may be omitted according to a trade-off between manufacturing cost and accuracy of the pseudo satellite navigation signal repeating device 100. For example, at least one of a function using the output intensity OS, the output amplifier/attenuator 160, the communication interface 110, a time correction unit 121 or a clock 122 may be omitted.

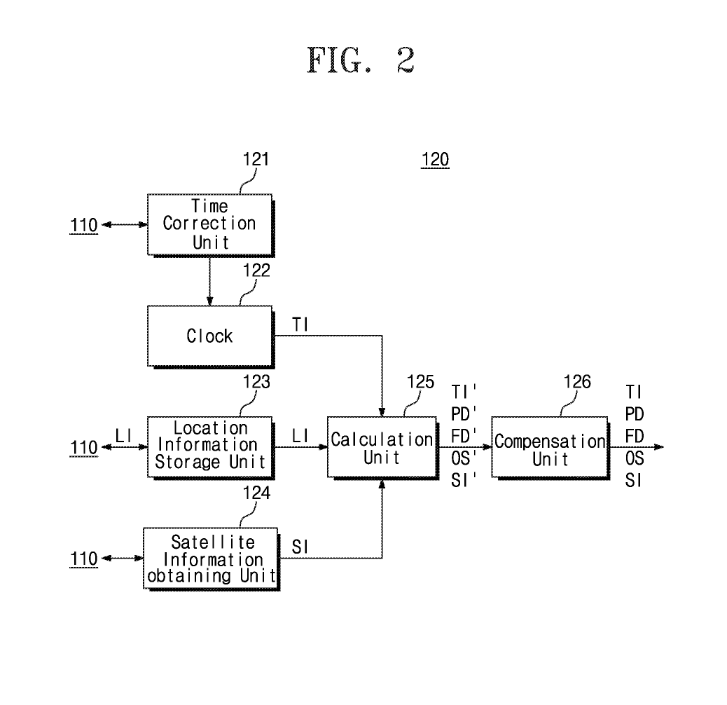

FIG. 2 is a block diagram of the controller 120 according to an example embodiment of the present disclosure. Referring to FIGS. 1 and 2, the controller 120 includes a time correction unit 121, a clock 122, a location information storage unit 123, a satellite information obtaining unit 124, a calculation unit 125, and a compensation unit 126.

The time correction unit 121 may come in contact with an external device, e.g., a time information server through the communication interface 110 and synchronize a time of the time information server with a time of the clock 122. That is, the time correction unit 121 may correct the time of the clock 122 to an accurate time. The clock 122 may provide time information TI to the calculation unit 125 according to a request of the calculation unit 125.

The location information storage unit 123 may receive and store location information LI from an external device through the communication interface 110. The location information storage unit 123 may provide the location information LI to the calculation unit 125 according to a request of the calculation unit 125.

The satellite information obtaining unit 124 may obtain information on navigation satellites from an external device, e.g., a global navigation satellite information server through the communication interface 110. For example, the satellite information obtaining unit 124 may obtain and store information of orbits of all navigation satellites participating in a global navigation satellite system (or all navigation satellites released to the public). The satellite information obtaining unit 124 may provide information SI of associated navigation satellites to the calculation unit 125 according to a request of the calculation unit 125.

The calculation unit 125 may obtain the time information TI from the clock 122, obtain the location information LI from the location information storage unit 123, and obtain the information SI of the associated navigation satellites from the satellite information obtaining unit 124. The calculation unit 125 may output the time information TI as raw time information TI′. The calculation unit 125 may calculate and output raw pseudo ranges PD′ from the location information LI and the information SI of the associated navigation satellites.

The calculation unit 125 may calculate and output raw Doppler frequencies FD′ from the location information LI and the information SI of the associated navigation satellites. The calculation unit 125 may calculate and output raw output intensities OS′, based on the raw pseudo ranges PD′. The calculation unit 125 may calculate and output raw output intensities OS′, based on the raw pseudo ranges PD′. The calculation unit 125 may output the information SI of the associated navigation satellites as raw information SI′ of the associated navigation satellites.

The compensation unit 126 may compensate at least one of the raw time information TI′, the raw pseudo ranges PD′, the raw Doppler frequencies FD′, the raw output intensities OS′, and the raw information SI′ of the associated navigation satellites by considering the earth's rotation, an ionospheric layer, and a convection layer. For example, the compensation unit 126 may perform compensation by considering Doppler effect caused by the earth's rotation, attenuation of the ionospheric layer and the convection layer, transmission delay or the like. A result of the compensation is output as the time information TI, the pseudo ranges PD, the Doppler frequencies FD, the output intensity OS, and the information SI of the associated navigation satellites.

In an example embodiment, some of components of the controller 200 shown in FIG. 2 may be omitted according to a trade-off between manufacturing cost and accuracy of the pseudo satellite navigation signal repeating device 100. For example, the compensation unit 126 may be omitted and an output of the calculation unit 125 may be output as the time information TI, the pseudo ranges PD, the Doppler frequencies FD, the output intensity OS, and the information SI of the associated navigation satellites.

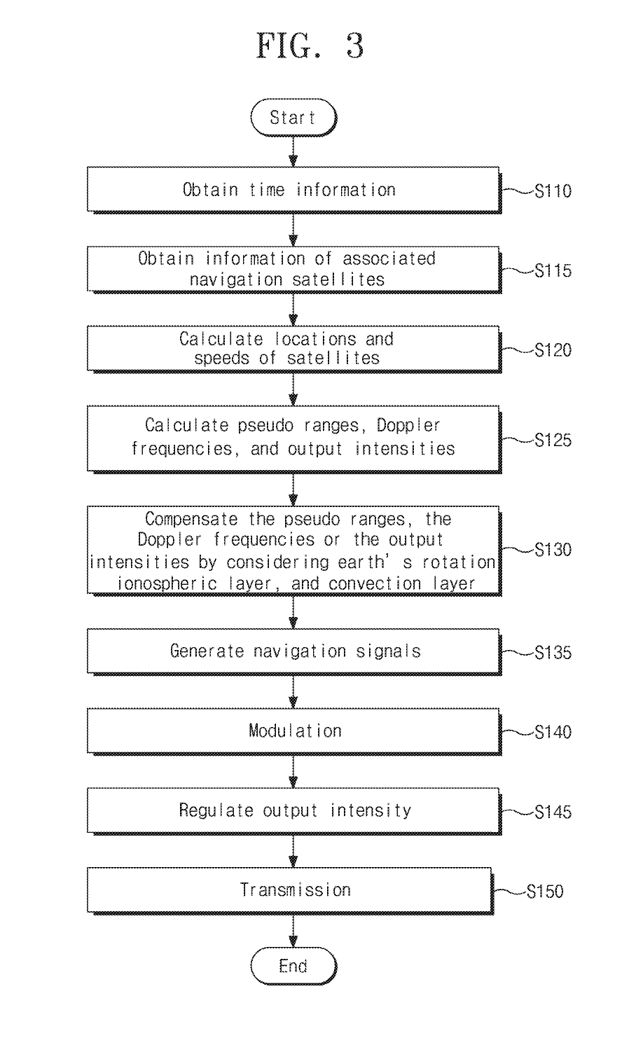

FIG. 3 is a flowchart illustrating an operating method of the pseudo satellite navigation signal repeating device 100 according to an example embodiment of the present disclosure. Referring to FIGS. 1 through 3, in step S110, the pseudo satellite navigation signal repeating device 100, e.g., the calculation unit 125 may obtain the time information TI. The calculation unit 125 may obtain the time information TI from the clock 122.

In step S115, the pseudo satellite navigation signal repeating device 100, e.g., the calculation unit 125 may obtain the information SI of the associated navigation satellites. The calculation unit 125 may detect navigation satellites transmitting navigation signals reaching the location information LI as associated navigation satellites at a current time that the time information TI indicates. The calculation unit 125 may search the satellite information obtaining unit 124 to obtain the orbit information of the associated navigation satellites and the information SI of the associated navigation satellites including pseudo random numbers.

In step S120, the pseudo satellite navigation signal repeating device 100, e.g., the calculation unit 125 may calculate locations and speeds of the associated navigation satellites. The calculation unit 125 may calculate locations and relative speeds of the associated navigation satellites, based on a current time that the time information TI indicates and the orbit information.

In step S125, the pseudo satellite navigation signal repeating device 100, e.g., the calculation unit 125 may calculate pseudo ranges (e.g., raw pseudo ranges PD′), Doppler frequencies (e.g., raw Doppler distances FD′), and output intensities (e.g., raw output intensities OS′).

In step S130, the pseudo satellite navigation signal repeating device 100, e.g., the compensation unit 126 may compensate the pseudo ranges (e.g., raw pseudo ranges PD′, the Doppler frequencies (e.g., raw Doppler frequencies FD′) or the output intensities (e.g., raw output intensities OS′) by considering the earth's rotation, the ionospheric layer, and the convection layer. The compensation unit 126 may further compensate the raw time information TI′ or the raw information SI of the associated navigation satellites.

In step S135, the pseudo satellite navigation signal repeating device 100, e.g., the signal generator 130 may generate navigation signals, based on the information SI of the associated navigation satellites, the pseudo ranges PD, and the time information TI. For example, the signal generator 130 may generate digital signals SD that are digital versions of base band of the navigation signals NS.

In step S140, the pseudo satellite navigation signal repeating device 100, e.g., the signal converter 140 and the modulator 150 may modulate the digital signals SD and output the modulated signals SR. The modulator 150 may modulate analog signals SA into different Doppler frequencies FD in response to the Doppler frequencies FD.

In step S145, the pseudo satellite navigation signal repeating device 100, e.g., the output amplifier/attenuator 160 may regulate intensities of the modulated signals SR, based on the output intensity OS. In step S150, the pseudo satellite navigation signal repeating device 100, e.g., the output amplifier/attenuator 160 may receive intensity-regulated signals as the navigation signals NS through the antenna 170.

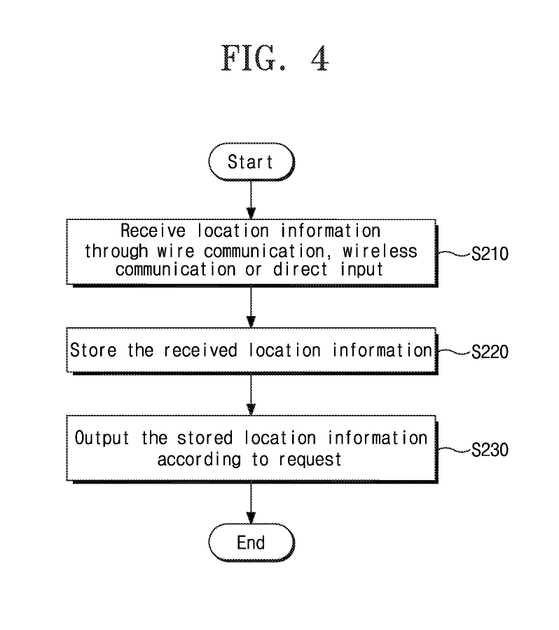

FIG. 4 is a flowchart illustrating an example of a method for storing the location information LI by the location information storage unit 123. Referring to FIGS. 2 and 4, in step S210, the location information storage unit 123 may receive the location information LI from an external device through wire communication, wireless communication or direct connection. The received location information LI may include information of a location at which the pseudo satellite navigation signal repeating device 100 is installed or is to be installed. For example, the location information LI may include latitude, longitude, and altitude.

In step S220, the location information storage unit 123 may store the received location information LI. For example, the location information storage unit 123 may include a volatile memory such as dynamic random access memory (DRAM) or static random access memory (SRAM) and a nonvolatile memory such as electrically erasable and programmable read only memory (EEPROM) or flash memory for storing the location information LI.

In step S230, the location information storage unit 123 may output the stored location information LI to the calculation unit 125 according to a request from the calculation unit 125.

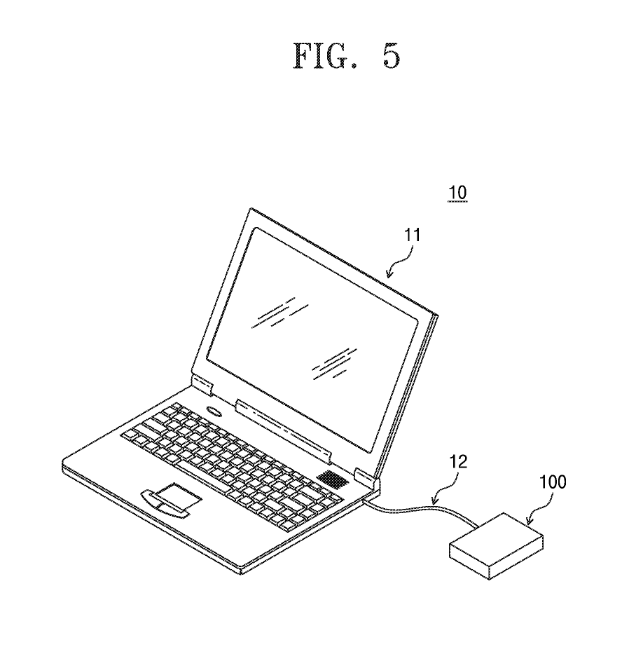

FIG. 5 is a conceptual diagram of a configuration to directly input location information to an external device through wire communication, as an example of a system 10 in which the location information LI is stored in the location information storage unit 125. Referring to FIGS. 2 and 5, the pseudo satellite navigation signal repeating device 100 may be connected to an external device, e.g., a computer 11. The pseudo satellite navigation signal repeating device 100 may receive the location information LI from the computer 111 through a cable 12 and store the received location information LI.

Since the location information LI of the location at which the pseudo satellite navigation signal repeating device 100 is installed is stored and used to calculate the pseudo ranges PD, the Doppler frequencies FD, and the output intensity OS, accuracy of navigation signals provided by the pseudo satellite navigation signal repeating device 100 is improved.

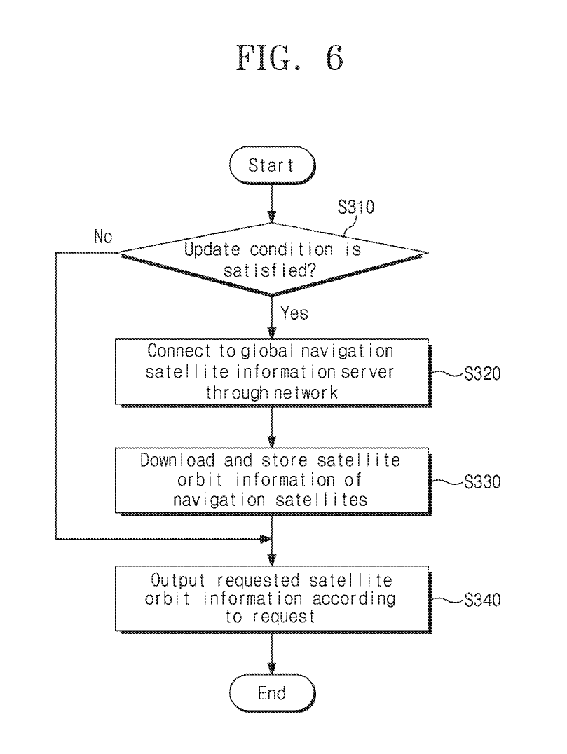

FIG. 6 is a flowchart illustrating an example of updating satellite information by the satellite information obtaining unit 124 according to an example embodiment of the present disclosure. Referring to FIGS. 2 and 6, in step S310, the satellite information obtaining unit 124 may determine whether an update condition is satisfied. For example, the update condition may be satisfied each time a predetermined time period (e.g., two hours) passes. When the update condition is satisfied, the flow proceeds to step S320.

In the step S320, the satellite information obtaining unit 124 may be connected to a navigation satellite orbit server through a network connected to the communication interface 110. In step S330, the satellite information obtaining unit 124 may download and store satellite orbit information of navigation satellites which are stored in the navigation satellite orbit server. For example, the satellite information obtaining unit 124 may download and store all satellite orbit information of the navigation satellites which can be obtained from the navigation satellite orbit server.

When the update condition is not satisfied or when the update condition is satisfied and after the steps S320 and S330 are performed, in step S340, the satellite information obtaining unit 124 may output requested satellite orbit information (e.g., associated satellite orbit information of associated navigation satellites) to the calculation unit 125 according to a request of the calculation unit 125.

That is, when the update condition is not satisfied, the satellite information obtaining unit 124 may output previously updated satellite orbit information of the navigation satellites according to a request of the calculation unit 125. When the update condition is satisfied, the satellite information obtaining unit 124 may update the satellite orbit information and output currently updated satellite orbit information according to a request of the calculation unit 125. That is, the satellite information obtaining unit 124 may output newest satellite orbit information according to the request of the calculation unit 125.

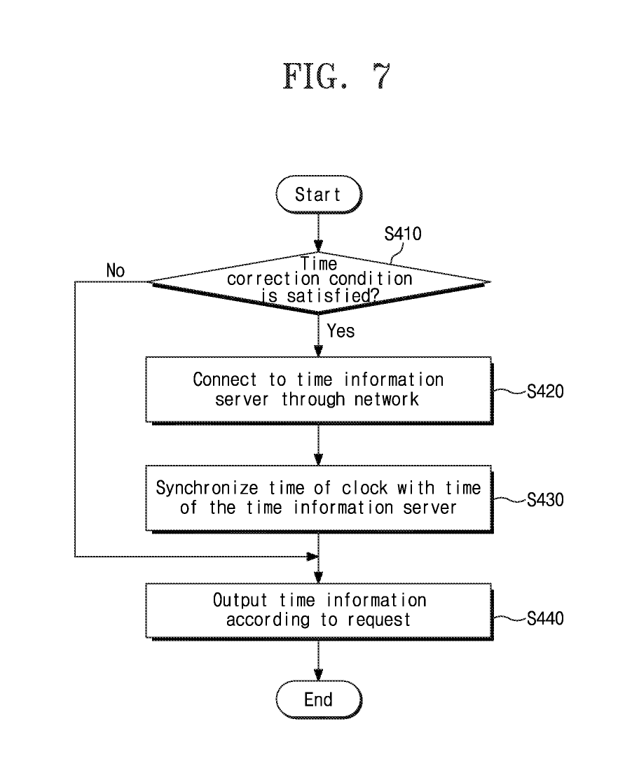

FIG. 7 is a flowchart illustrating an example of correcting a time of the clock 122 by the time correction unit 121 according to an example embodiment of the present disclosure. Referring to FIGS. 2 and 7, in step S410, the time correction unit 121 may determine whether a time correction condition is satisfied. For example, the correction condition may be satisfied each time a predetermined time period (e.g., a single day) passes. When the correction condition is satisfied, the flow proceeds to step S420.

In the step S420, the time correction unit 121 may be connected to a time information server through a network connected to the communication interface 110. In step S430, the time correction unit 121 may synchronize a time of the clock 122 with a time of the time information server.

When the correction condition is not satisfied or when the correction condition is satisfied and after the steps S420 and S420 are performed, in step S440, the clock 122 may output the time information TI to the calculation unit 125 according to a request of the calculation unit 125.

That is, when the correction condition is not satisfied, the clock 122 may output previously corrected time information TI according to a request of the calculation unit 125. When the correction condition is satisfied, the time correction unit 121 may correct a time of the clock 122 and output currently corrected time information TO according to a request of the calculation unit 125. That is, the clock 122 may output newest time information TI according to the request of the calculation unit 125.

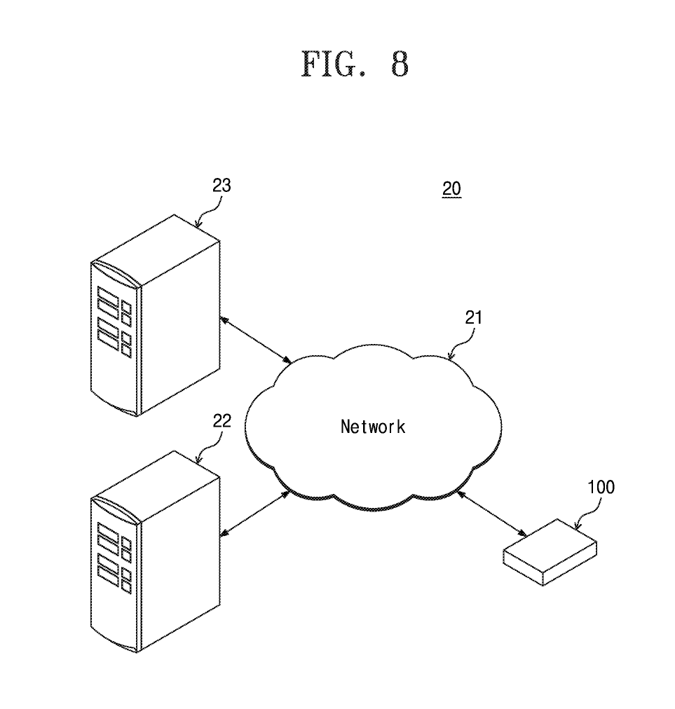

FIG. 8 illustrates an example of a system in which the pseudo satellite navigation signal repeating device 100 updates information of satellite orbits and time information TI. Referring to FIGS. 1, 2, and 8, the communication interface 110 of the pseudo satellite navigation signal repeating device 100 may be connected to the network 21. The network 21 may include Internet. The network 21 may be connected to the navigation satellite orbit server 22 and the time information server 23.

The satellite information obtaining unit 124 of the pseudo satellite navigation signal repeating device 100 may download information of satellite orbits from the navigation satellite orbit server 22 through the network 21 and update the downloaded information. The time correction unit 121 of the pseudo satellite navigation signal repeating device 100 may obtain time information from the time information server 23 to correct a time of the clock 122.

The pseudo satellite navigation signal repeating device 100 allows the information of the satellite orbits and the time information TI to be kept up-to-date through the network 21. Thus, the pseudo satellite navigation signal repeating device 100 may normally simulate (or generate) navigation signals of the navigation satellites even in an environment (e.g., basement or indoor space) that the navigation signals does not reach.

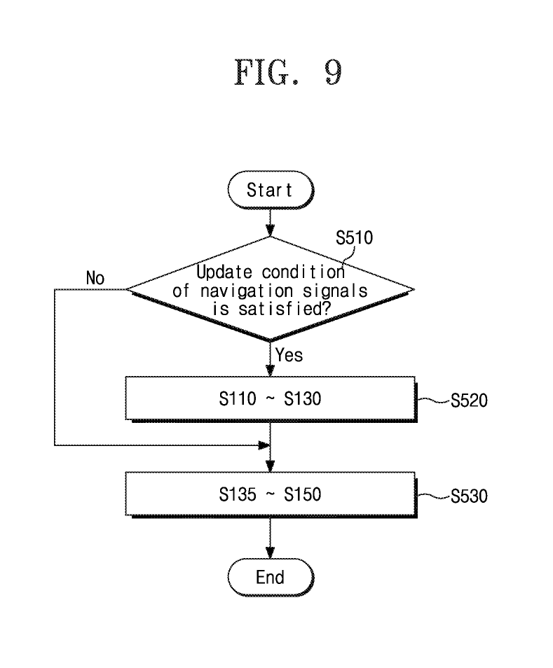

FIG. 9 is a flowchart illustrating an example of updating navigation signals by the pseudo satellite navigation signal repeating device 100 according to an example embodiment of the present disclosure. Referring to FIGS. 1 and 9, in step S510, the controller 120 may determine whether an update condition of navigation signals is satisfied. For example, the update condition may be satisfied each time a predetermined time period (e.g., two seconds). When the update condition is satisfied, the flow proceeds to step S520.

In step S520, the controller 120 may perform the steps S110 to S130 in FIG. 3 to obtain the time information TI and the information SI of the associated navigation satellites and calculate the pseudo ranges PD, the Doppler frequencies FD, and the output intensity OS. When the update condition is not satisfied or when the update condition is satisfied and after the step S520 is performed, in step S530, the pseudo satellite navigation signal repeating device 100 may perform the steps S135 to S150 in FIG. 3 to receive the navigation signals NS.

That is, when the update condition is not satisfied, the pseudo satellite navigation signal repeating device 100 may receive previously updated (or calculated or generated) navigation signals NS. When the update condition is satisfied, the pseudo satellite navigation signal repeating device 100 may update (or calculate or generate) currently updated (or calculated or generated) navigation signals. That is, the pseudo satellite navigation signal repeating device 100 may periodically update the navigation signals to newest versions.

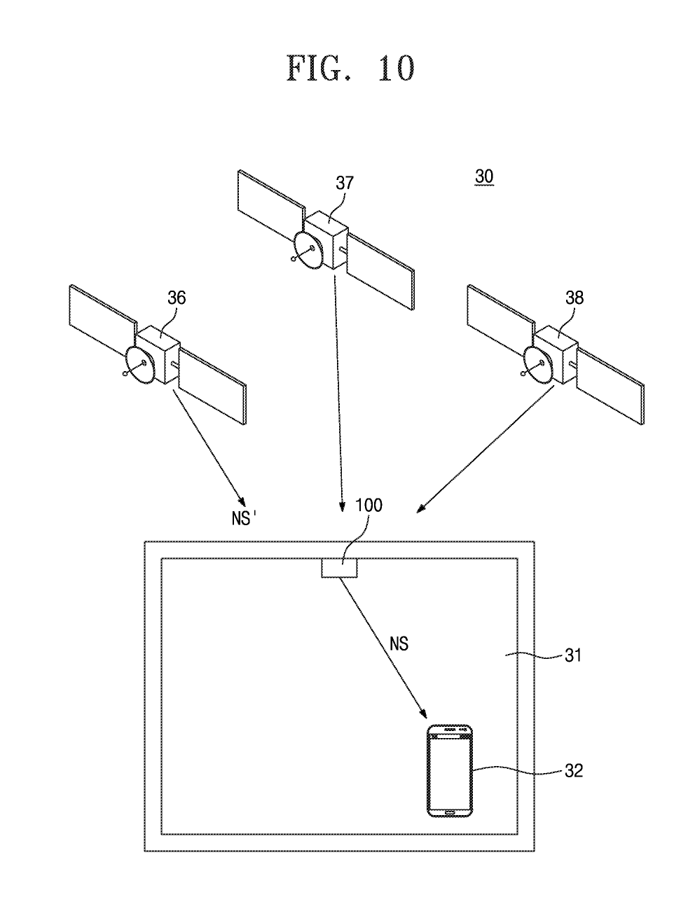

FIG. 10 illustrates an example of a system in which a pseudo satellite navigation signal repeating device 100 transmits navigation signals to a user device 32 in an indoor space 31. Referring to FIG. 10, when the user device 32 is disposed in the indoor space 31, navigation signals NS' transmitted from navigation satellites 36 to 38 cannot reach the user device 32. That is, the user device 32 cannot receive the navigation signals NS' from the navigation satellites 36 to 38.

When the pseudo satellite navigation signal repeating device 100 is disposed in the indoor space 31, the pseudo satellite navigation signal repeating device 100 cannot also receive the navigation signals NS' from the navigation satellites 36 to 38. However, as described with reference to FIGS. 1 through 9, the pseudo satellite navigation signal repeating device 100 may obtain information through a network such as Internet and generate (or simulate) navigation signals NS based on the obtained information. The pseudo satellite navigation signal repeating device 100 may receive the generated (or simulated) navigation signals NS in the indoor space 31.

The user device 32 may receive the navigation signals NS from the pseudo satellite navigation signal repeating device 100 and obtain location information based on the received navigation signals NS. For example, the user device 32 may obtain location information LI stored in the location information storage unit 123 of the pseudo satellite navigation signal repeating device 100 from the navigation signals NS. That is, the user device 32 may identify the location information LI stored in the location information storage unit 123 of the pseudo satellite navigation signal repeating device 100 as its own location information.

As described above, according to the present disclosure, the user device 32 may use a service based on location information through the pseudo satellite navigation signal repeating device 100 even when the user device 32 is disposed in the indoor space 31 that navigation signals from the navigation satellites 36 to 38 cannot reach. The navigation signals NS of the pseudo satellite navigation signal repeating device 100 and the navigation signals NS' of the navigation satellites 36 to 38 have the same format and the same form (or type) of information. Thus, the pseudo satellite navigation signal repeating device 100 has higher compatibility than an existing global navigation satellite system.

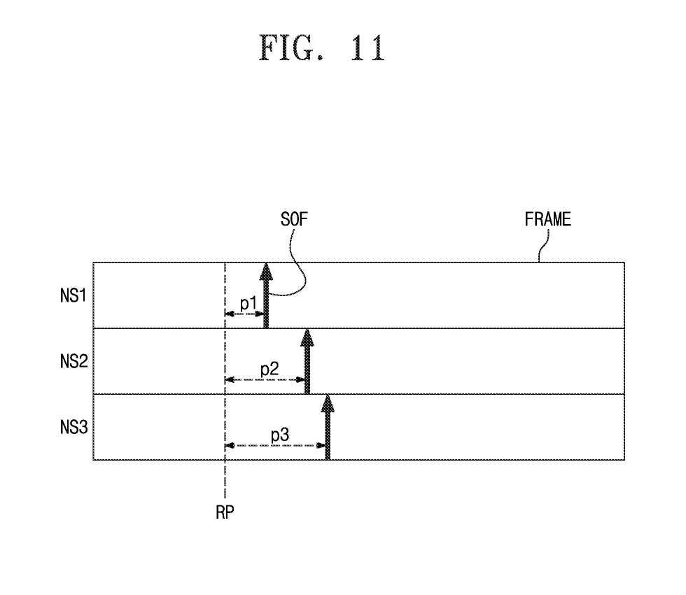

FIG. 11 illustrates an example of navigation signals NS1 to NS3 that the pseudo satellite navigation signal repeating device 100 receives. More specifically, FIG. 11 illustrates an example in which the pseudo satellite navigation signal repeating device 100 does not receive satellite navigation signals and generates and receives the navigation signals NS1 to NS3 based on location information in a space in which the satellite navigation signals are disconnected.

Referring to FIGS. 1, 10, and 11, the pseudo satellite navigation signal repeating device 100 may receive navigation signals NS1 to NS3 corresponding to the number of associated navigation satellites 36 to 38. On the basis of the pseudo ranges PD, the controller 120 may determine the delay of a location of start of frame (SOF) of each of the navigation signals NS1 to NS3 which is delayed from a reference point RP.

For example, as the pseudo distance increases, the delay may increase. As the pseudo distance decreases, the delay may decrease. For example, first delay ρ1 of the first navigation signal NS1 may be smaller than second delay ρ2 of the second navigation signal NS2. The second delay ρ2 of the second navigation signal NS2 may be smaller than third delay ρ3 of the third navigation signal NS3. The delay ρ of each of the navigation signals NS1 to NS3 may be calculated according to the Equation (1) below.

ρ=\sqrt{(x−xᵤ)²+(y−yᵤ)²+(z−zᵤ)²}bᵤ Equation (1)

In the Equation (1), satellite coordinates (x, y, z) may indicate a location of a navigation satellite that is calculated from information of an orbit. User coordinates (xᵤ, yᵤ, zᵤ) may indicate a location of the user device 32. A bias bᵤ may be a constant. As indicated in the Equation (1), the delay ρ increases as a distance between the navigation satellites 36 to 38 and the user device 32 increases.

Relative locations of the navigation satellites 36 to 38 to the user device 32 change as the navigation satellites 36 to 38 revolve along the earth's orbit. A described with reference to FIG. 9, the pseudo satellite navigation signal repeating device 100 may periodically update the navigation signals to reflect location change depending on revolution of navigation satellites. As the location change is reflected, a location of start of frame (SOF) of each of the navigation signals NS1 to NS3 may also change.

For example, when a specific navigation satellite approaches the user device 32 with the lapse of time, the delay ρ of SOF of a navigation signal received by the navigation satellite may gradually decrease. That is, a location of the SOF may advance.

When the specific navigation satellite goes far away from the user device 32 with the lapse of time, the delay ρ of SOF of a navigation signal received by the navigation satellite may gradually increase. That is, a location of the SOF may be further delayed.

When a new navigation satellite is added as an associated navigation satellite with the lapse of time, the pseudo satellite navigation signal repeating device 100 may additionally transmit a corresponding navigation signal. When the specific navigation satellite is excluded from the associated navigation with the lapse of time, the pseudo satellite navigation signal repeating device 100 may remove a corresponding navigation signal.

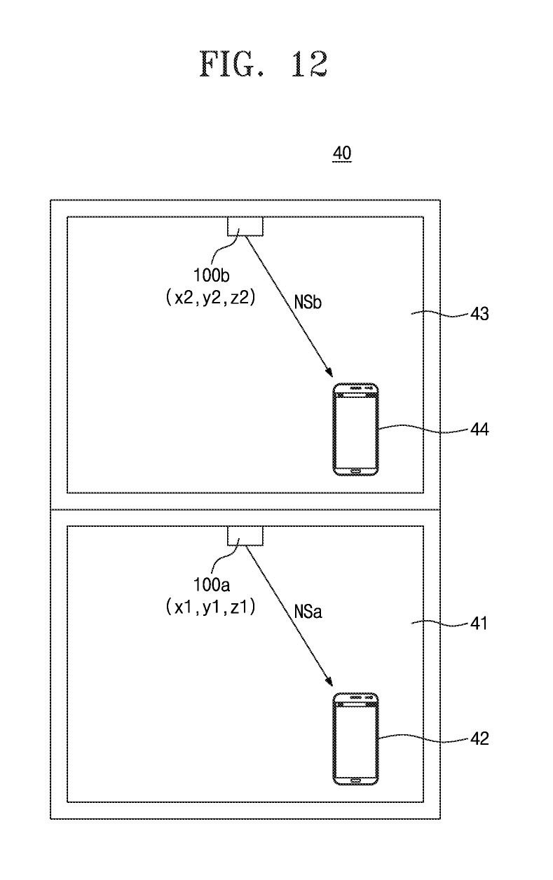

FIG. 12 illustrates another example of a system 40 in which the pseudo satellite navigation signal repeating device 100 according to an example embodiment of the present disclosure receives navigation signals NS. As compared to FIG. 10, a first indoor space 41 and a second indoor space 43 separated from the first indoor space 41 are provided in the system 40. A first pseudo satellite navigation signal repeating device 100a and a first user device 42 may be disposed in the first indoor space 41, and a second pseudo satellite navigation signal repeating device 100b and a second user device 44 may be disposed in the second indoor space 43.

In an example embodiment, the second indoor space 43 may be an overlying layer of the first indoor space 41. The first pseudo satellite navigation signal repeating device 100a may store first coordinates (x1, y1, z1) corresponding to the first indoor space 41 as location information LI. The second pseudo satellite navigation signal repeating device 100b may store second coordinates (x2, y2, z2) corresponding to the second indoor space 42 as location information LI.

Since an altitude of the second indoor space 43 is greater than that of the first indoor space 41, a second altitude coordinate z2 of the second pseudo satellite navigation signal repeating device 100b may be greater than a first altitude coordinate z1 of the first pseudo satellite navigation signal repeating device 100a. The first and second pseudo satellite navigation signal devices may generate navigation signals NSa and NSb by considering the altitude difference and transmit the generated navigation signals NSa and NSb.

The first user device 42 receives the navigation signals NSa generated based on the first coordinates (x1, y1, z1). Thus, the first user device 42 may calculate the first coordinates (x1, y1, z1) as its own coordinates. The second user device 44 may receive the navigation signals NSb generated based on the second coordinates (x2, y2, z2). Thus, the second user device 44 may identify the second coordinates (x2, y2, z2) as its own coordinates.

A conventional repeater retransmits navigation signals received from an antenna mounted on the outside (e.g., roof) to the basement or indoor space. Thus, user devices receiving navigation signals from a conventional repeater in the indoor commonly identify a location at which an antenna mounted on the outside as their location. Meanwhile, according to the present disclosure, the user devices 42 and 44 identify coordinates of closest pseudo satellite navigation signal repeating device 100 as their coordinates. Thus, accuracy of determining coordinates by a user device is improved.

On the basis of the improved accuracy, a navigation service may be provided in a wide indoor space such as department store or wholesale mart or a wide underground space such as underground parking lot or underground shopping center.

According to the present disclosure, a pseudo satellite navigation signal repeating device compares a current location with orbit information of satellites to output simulated versions of navigation signals of navigation satellites. Since the current location is reflected, a pseudo satellite navigation device with more improved accuracy than existing studied means and an operating method of the pseudo satellite navigation device are provided. In addition, the pseudo satellite navigation signal repeating device transmits the same navigation signals as navigation signals that navigation satellites transmit. Thus, a pseudo satellite navigation signal repeating device with more improved compatibility than existing studied means and an operating method of the pseudo satellite navigation signal repeating device are provided.

Although the present disclosure and its advantages have been described in detail, it should be understood that various changes, substitutions and alterations can be made herein without departing from the spirit and scope of the disclosure as defined by the following claims.

1. A pseudo satellite navigation signal repeating device comprising:
a communication interface configured to collect orbit information of navigation satellites from a global navigation satellite information server through a network;
a controller configured to calculate pseudo ranges from associated navigation satellites based on associated orbit information of the associated navigation satellites among orbit information of all the navigation satellites;
a signal generator configured to generate navigation signals of the associated navigation satellites based on the pseudo ranges;
a signal converter configured to convert the navigation signals into analog signals of base band or intermediate band; and
a modulator configured to modulate the analog signals using a wireless carrier signal.

2. The pseudo satellite navigation signal repeating device as set forth in claim 1, wherein:
the controller is configured to select navigation satellites calculated to transmit navigation signals to a current location at a current time as the associated navigation satellites, based on the orbit information.

3. The pseudo satellite navigation signal repeating device as set forth in claim 1, wherein:
the signal generator is configured to adjust timings of starts of frames of the navigation signals, based on the pseudo ranges.

4. The pseudo satellite navigation signal repeating device as set forth in claim 1, wherein:
the controller is configured to calculate Doppler frequencies of the navigation signals, based on the associated orbit information, and
the modulator is configured to modulate the analog signals using the Doppler frequencies, respectively.

5. The pseudo satellite navigation signal repeating device as set forth in claim 1, wherein:
the controller is configured to calculate output intensity, based on information of a transmission range.

6. The pseudo satellite navigation signal repeating device as set forth in claim 5, further comprising:
an output amplifier/attenuator configured to regulate intensities of the modulated signals based on the output intensity and output the regulated signals.

7. The pseudo satellite navigation signal repeating device as set forth in claim 1, wherein:
the controller includes a location information storage unit configured to store information on a location at which the pseudo satellite navigation signal repeating device is installed, and
the controller is configured to calculate the pseudo ranges, based on the associated orbit information and the location information.

8. The pseudo satellite navigation signal repeating device as set forth in claim 7, wherein:
the location information storage unit is configured to receive and store the location information through the communication interface.

9. The pseudo satellite navigation signal repeating device as set forth in claim 1, wherein:
the controller includes a satellite information obtaining unit configured to obtain orbit information of the navigation satellites by periodically connecting to the global navigation satellite information server through the communication interface.

10. The pseudo satellite navigation signal repeating device as set forth in claim 1, wherein:
the controller includes a clock;
the controller is configured to output time information obtained from the clock together with the pseudo ranges to the signal generator; and
the signal generator is configured to generate the navigation signals, based on the pseudo ranges and the time information.

11. The pseudo satellite navigation signal repeating device as set forth in claim 10, wherein:
the controller includes a time correction unit configured to synchronize a time of the clock with a time of a time information server by periodically connecting to the time information server through the communication interface.

12. The pseudo satellite navigation signal repeating device as set forth in claim 1, wherein:
the controller is configured to periodically reselect the associated navigation satellites and recalculate pseudo ranges of the reselected navigation satellites.

13. The pseudo satellite navigation signal repeating device as set forth in claim 1, wherein:
the controller is configured to compensate the pseudo ranges by considering earth's rotation, an ionospheric layer, and a convection layer

14. An operating method of a pseudo satellite navigation signal repeating device, the operating method comprising:
obtaining associated orbit information of orbit satellites associated with a current location;
calculating locations of the associated navigation satellites, based on the associated orbit information;
calculating pseudo ranges of the associated navigation satellites, based on the locations;
generating navigation signals of the associated navigation satellites, based on the pseudo ranges; and
modulating the navigation signals using a wireless carrier frequency.

15. The operating method as set forth in claim 14, further comprising:
obtaining time information, and
wherein generating the navigation signals is performed based on the obtained time information.

16. The operating method as set forth in claim 14, further comprising:
calculating relative speeds of the associated navigation satellites, based on the associated orbit information; and
calculating Doppler frequencies of the associated navigation satellites, based on the relative speeds, and
wherein modulating the navigation signals includes modulating the navigation signals using wireless carrier frequencies based on the Doppler frequencies, respectively.

17. The operating method as set forth in claim 14, further comprising:
correcting the pseudo ranges by considering earth's rotation, an ionospheric layer, and a convection layer, and
wherein generating the navigation signals is performed based on the corrected pseudo ranges.

18. The operating method as set forth in claim 14, further comprising:
calculating output intensity of the navigation signals, based on information of a transmission range;
adjusting intensities of the modulated navigation signals, based on the output intensity; and
transmitting the adjusted navigation signals.

19. The operating method as set forth in claim 14, further comprising:
periodically obtaining orbit information of navigation satellites from a global navigation satellite information server through a network, and
wherein the associated orbit information of the associated navigation satellites is selected from the orbit information.

20. The operating method as set forth in claim 14, wherein:
obtaining the associated orbit information, calculating the locations, calculating the pseudo ranges, and generating the navigation signals are periodically performed; and
modulating the navigation signals includes modulating currently updated navigation signals or previously updated navigation signals.
